(19) United States
(12) Patent Application Publication
(10) Pub. No.: US 2011/0254202 A1
(43) Pub. Date: Oct. 20, 2011

(54) MOULDING CANNULAE AND SMALL DEEP HOLES

(75) Inventor: Andreas Aeschlimann, Caulfield North (AU)

(73) Assignee: SSB Technology Pty Ltd, Scoresby, Victoria (AU)

(21) Appl. No.: 13/142,246

(22) PCT Filed: Dec. 23, 2009
(86) PCT No.: PCT/AU2009/001695

§ 371 Date: Jun. 24, 2011

(30) Foreign Application Priority Data
Dec. 24, 2008 (AU) 2008906616

(51) Int. Cl. B29C 45/40

(52) U.S. Cl. 264/328.1; 425/577

(57) ABSTRACT

The present invention provides apparatus and methods for injection moulding polymeric articles. The method includes injecting pressurised liquid polymer into a mould cavity, the cavity incorporating a core pin and a pressure distribution means. Preferably the article is a cannula.

The invention provides a mould for injection moulding articles from polymeric materials, the mould comprising at least two parts defining a cavity having a conduit portion incorporating a needle portion; a channel for liquid polymer ingress; a channel for pressurised fluid ingress; a core pin for defining the conduit of a cannula, and a pressure distribution means for controlling the distribution of the pressurised liquid polymer. The end surface of the pressure distribution means defines the tip geometry of the cannula. The mould may incorporate a plurality of cavities. The method includes moving the pressure distribution means in a controlled manner to define the conduit of the cannula.

### FIELD OF INVENTION

This invention relates to the field of manufacturing cannulae, in particular polymeric cannulae, and more particularly, methods and apparatus for moulding of polymeric reconstitution needles.

### BACKGROUND TO THE INVENTION

It is often necessary to store substances, such as pharmaceutically active materials, in a dry state so that they do not degrade and lose biological activity in an aqueous environment, although the method of delivery of the substances may be in aqueous solution. Particularly in the case of pharmaceutically active materials, the substances must be kept aseptic at all times. Transferring aseptic materials between containers, such as when active solutions are reconstituted, while maintaining aseptic conditions is fraught with difficulties. Several products for providing effective reconstitution of active solutions are known in the art, such as described in U.S. Pat. No. 5,226,900 or EP 1,626,758. Any syringe with adequate strength in the needle may be used, such as those with 18-gauge needles. Ideally, a solution will be a reconstitution needle that is strong enough to penetrate the thick septa conventionally used to stopper vials and maintain aseptic conditions. For this reason, many reconstitution syringes comprise of a metal needle to provide adequate strength to puncture and penetrate septa.

A reconstitution needle should be cheap and easy to manufacture and be disposable after a single use. Polymeric materials have been shown to be useful in the manufacture of cheap and disposable syringes. For example, Stevens, Smith and Bartlett described a method for manufacturing polymeric hypodermic needles using gas-assisted injection moulding in U.S. Pat. No. 5,620,639, hereinafter referred to as the '639 patent, which is incorporated herein by reference. The method disclosed in the '639 patent advantageously uses the properties of a liquid polymer and a working fluid for displacing liquid polymer from the interior of channel in a mould containing liquid polymer. The working fluid of the '639 patent is advantageously a gas that reliably creates an integrated “needle” comprising a cannula portion and a mounting hub portion for connection to a syringe, the cannula defining a conduit for passage of fluids between a reservoir and a subject. The method of the '639 patent is particularly useful for injection moulding small gauge cannulae for a single use and then disposal. However, a reconstitution needle requires a thicker gauge to avoid breaking the needle.

Cannulae smaller than 17-gauge define a conduit which is smaller than about 1 mm internal diameter, making polymeric materials less suitable for use in their manufacture. Generally, medical cannulae and hypodermic needles smaller than 17-gauge are made of steel because of the difficulty in manufacturing a polymeric cannula defining a conduit of consistent internal diameter less than about 1 mm and the superior material properties of stainless steel.

However, conventional polymer moulding techniques can be used to manufacture medical cannulae in some instances, in particular, with the use of a core pin around which the injected polymer forms the conduit. Generally a core pin of about 1.0 mm diameter is used, resulting in an outer diameter of the polymer cannula of about 3 mm, or 11-gauge. A larger external diameter increases the wall thickness of the cannula and ensures that injection pressures during the moulding process can be minimised to avoid bending of the small core pin. The length of the cannula must be short to avoid the potential for bending when conventional polymer moulding techniques are used. Bending of the core pin must be avoided to minimise uneven wall thickness in the moulded cannulae and reduce the potential for breaking of the fragile core pin during the de-moulding step when the formed cannula is removed from the mould.

What is needed are methods and apparatus for manufacturing reconstitution needles which enable the manufacture of polymer cannulae which are smaller than 17-gauge but possess adequate strength to penetrate currently known septa.

### BRIEF DESCRIPTION OF THE DRAWINGS

FIG. 1 shows in longitudinal section an embodiment of the invention being a mould incorporating a core pin and a pressure distribution means.

FIG. 2 shows the embodiment of FIG. 1 where the liquid polymer injection is complete.

FIG. 3 shows the embodiment of FIG. 2 where the injection of liquid polymer is complete and the core pin and pressure distribution means are being separated from the formed article.

FIG. 4 shows an injection moulded cannula being ejected from the mould in which it was formed.

FIG. 5 shows the steps of fluid-assisted injection-moulding of liquid polymer to form a cannula with a lumen therethrough.

FIG. 6 shows in longitudinal cross section an embodiment of a cannula formed according to the invention in comparison to a cannula formed according to methods currently known in the art.

FIG. 7 shows in perspective view 3 embodiments of cannulae made according to the invention.

FIG. 8 shows in perspective view an embodiment of a cannula with a needle tip made according to the invention.

FIG. 9 shows in perspective view an alternative embodiment of a cannula having an alternative tip made according to the invention.

### SUMMARY OF THE INVENTION

The present invention provides apparatus and methods for injection-moulding of articles from polymeric materials. It is an object of the invention to provide apparatus and methods of manufacturing polymeric articles with reduced variation in wall thickness. Preferably the articles are cannula, and more preferably, reconstitution cannula. The cannulae may have very small conduits or bores. It is an object of the invention to provide apparatus and methods to reduce the amount of material needed for forming an article from polymeric material. It is a further object of the invention to provide a method of manufacturing articles with reduced injection cycle periods. It is a further object of the invention to provide apparatus for manufacturing cannulae of variable lengths. A further object of the invention is to provide an apparatus to mould small holes with a diameter/depth ratio of 1:20 or less.

In one aspect, the invention provides a mould for injection moulding of polymeric materials, the mould comprising at least two parts defining a cavity, the mould comprising a conduit portion, a channel for liquid polymer ingress, a core pin, and a pressure distribution means. The conduit portion may be a cannula or a bore or a small deep hole. The mould may be used for forming needles, syringes, particularly reconstitution syringes and the like. However, the mould is suitable for injecting moulding any article with a substantially constant cross-sectional area. This preferably includes cylindrical shapes, but may include shapes having angles in cross-section. The pressure distribution means may take alternative form, such as that of a sleeve or a ring. Preferably, the pressure distribution means comprises of a material that is an efficient transferor of heat, such as a metal. Such a material may assist with the cooling and article formation so that the moulding cycle of suitable articles is as short as possible. An end of the pressure distribution means may include a surface at an angle from the long axis so that a needle tip may be shaped in the mould. Alternatively, the end of the pressure distribution means may be substantially flat. In such cases, needles may be formed in the mould, which have particular use in penetrating thick materials, such as reconstitution needles used for re-constituting materials for injection. The cavity of the mould preferably is a cylindrical shape, resulting in cylindrical injection moulded articles. Most preferably, the conduit portion of the mould incorporates a needle portion so that articles injection moulded with the mould incorporate a needle. The mould may incorporate a plurality of conduits to form a plurality of articles with one moulding cycle. Preferably, the mould incorporates at least one stabliser for stabilising the core pin.

The invention may provide in some embodiments a conduit portion the length of which is at least about 20 times the diameter of the core pin.

In another aspect, the invention provides a method for forming an article from liquid polymeric material, the method comprising the steps of injecting pressurised liquid polymer into the cavity of a mould while providing a resistance pressure against the injecting pressure. The method may include distributing the pressurised liquid polymer throughout the cavity by the resistance pressure. The method may include the step of controlling the resistance pressure with a programmed microprocessor. The method may include the step of defining the length of a conduit with the resistance pressure. The method may include injecting at least a second pressurised liquid polymer. The at least second pressurised liquid polymer may be different from the first or subsequent liquid polymers. The method may include the step of dispersing the latent heat of the pressurised liquid polymer while providing the resistance pressure to distribute the liquid polymer. The method may be used to define a conduit, bore or small deep hole. The length of the conduit may be at least 20 times the diameter of the conduit. The method may be used to form cylindrical articles incorporating a conduit. Preferably, the articles are needles, syringes, and the like. Most preferably the articles are reconstitution needles. However, the method may be used to form any shaped article forming a conduit, such as articles having angular portions in cross-section. The method may be used to form a plurality of articles with a single injection of liquid polymer.

### DESCRIPTION OF THE INVENTION AND MOST PREFERRED EMBODIMENTS

The objects of the invention are best understood with reference to the embodiments described herein and with reference to the figures. FIGS. 1 to 9 show embodiments of the apparatus and method of the invention. It will be understood by those skilled in the art that the invention is not limited to the embodiments shown in the figures but includes embodiments not illustrated but within the scope of the claims appended hereto.

The invention includes injection moulding apparatus for moulding at least one cannula, bore or small deep hole the apparatus incorporating at least one core pin and a pressure distribution means for controlling the distribution of polymeric melt within the cavity of the mould. An embodiment with a single core pin is shown, but it will be understood that the scope of the invention includes a plurality of core pins in a single cannula, each core pin defining a conduit for transfer of materials. Further, the invention includes a mould incorporating cavities to mould a plurality of cannulae.

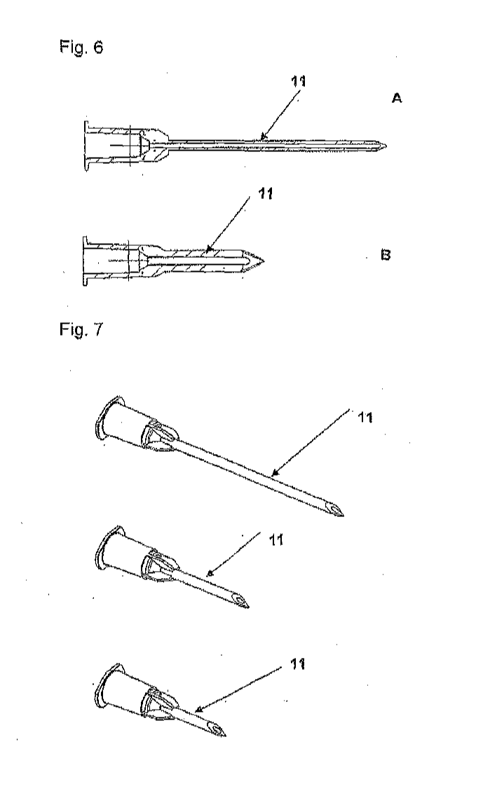

The invention includes a method for moulding polymeric articles shown in boxes 101 to 109 in FIG. 5, comprising of a step of providing a biasing pressure against the pressure of the injection moulded polymeric melt material during injection into the cavity. A moulding cycle begins 101 with a means to define a conduit through a cannula positioned within a mould and a pressure distribution means 102 for providing a pressure opposing that of liquid polymer melt material positioned in a closed mould 103 which defines a cavity of the desired shape, such as a cannula. Liquid polymer melt material is injected into the mould cavity 104 using pressures and times known in the art. Preferably, the injection time of polymer ingress is about 0.2 to 0.8 sec at a speed of about 20 to 200 mm sec⁻¹ and at a pressure about 800 to 2000 bar, filling the cavity with liquid polymer melt material. As the liquid polymer melt material fills the cavity, a pressure distribution means at the distal surface of the liquid polymer is simultaneously moved distally at about the same speed of about 20 to 200 mm sec⁻¹ as the liquid polymer enters the cavity 105.

The coordinated movement of the pressure distribution means helps to distribute the pressurised liquid polymer and to minimise bending of the core pin to provide a reproducibly straight conduit with even walls. As the liquid polymer fills the mould cavity the pressure distribution means moves to the most distal position from the polymer injection point 106, at which time the mould may be opened 108 for removal or ejection of the solidified article 109 and completion of the moulding cycle 110. The method may be used for moulding articles with more than a single polymeric melt material. For example, the method may be used in multi-component moulding techniques where more than one polymeric material with differing parameters is needed. In such cases, the method may repeated as shown at 108 in FIG. 5, where the steps include the step of repeating steps shown in 104 to 107.

FIG. 6 shows a cannula 11 made using the method of the invention compared to a commercially available cannula 50 made using current methods known in the art. A comparison reveals that the method of the invention makes it possible to manufacture much longer cannula with narrower diameters than the methods in the art. Most advantageously, cannulae manufactured according to the method of the invention may have a ratio of internal diameter to length of 1:50 or less.

The biasing or resistance pressure most advantageously operates to distribute the melt evenly within the mould cavity while minimizing any movement of a core pin within the cavity around which the melt forms a conduit. The method provides a conduit with reproducibly consistent wall diameter with the straight conduit forming the cannula. The method is advantageously used in injection moulded formation of reconstitution needles or similar cylindrical articles. The method makes it possible to provide reconstitution needles having adequate strength to penetrate and traverse a barrier, such as a plug characteristic of a vial containing material for reconstitution with a liquid from another vial. The method may also be used to form any polymeric article requiring a reproducible wall thickness, such as square or rectangular articles with constant cross sections. Most advantageously, because the amount of polymeric melt and its movement in the mould is controlled, the method may require as little as 25% of the polymeric material required to manufacture a similar article with known injection moulding techniques.

The pressure distribution means preferably comprises of a metallic material having a characteristic coefficient of heat transfer which helps to efficiently and more quickly transfer the heat from the melt to surrounding materials. This heat transfer most advantageously increases the rate of temperature drop of the melt in the mould, and the rate of solidification of the melt. In turn, the cycle time of the formation of an article using the apparatus and method of the invention is reduced compared to other apparatus and methods known in the art. The reduced cycle time also may increase the productivity of the apparatus and methods disclosed herein over those known in the art.

In the figures, polymeric melt material suitable for injection moulded cannula is represented as a solid black material 1. The polymeric material may be any suitable material for injection moulding such as the materials described in the '639 patent and further materials known in the art.

FIG. 1 shows liquid polymeric material 1 entering the cavity 3 of a mould 2 having several components. Ingress of the liquid polymeric material occurs under pressure from the left-hand side in this illustration. As shown in FIG. 1, the mould is closed and ready for injection of polymeric melt. The pressurised liquid polymeric melt 1 fills the cavity 3 and around a core pin 5 to abut the surface of a pressure distribution means 9. The distribution of the pressurised polymeric material 1 around the core pin 5 is controlled by the pressure distribution means 9, which is under pressure that is slightly greater than that of the polymeric material 1. The core pin 5 is stabilised by having its ends 6 firmly engaged in a stabiliser 7 at the injection end and at the distal end 8. The stabiliser at the distal end may comprise of a second element such as a plate 12 as illustrated. The distal stabilisers 8, 12 may be positioned pneumatically, hydraulically, or even during the opening stroke of the mould in operation. The stabiliser 7 at the injection end is a mechanically driven core forming the internal diameter of the cannula or needle incorporating the geometry of a luer hub. It is known in the art of injection moulding that stabilising the ends of the core pin 5 may not be adequate to ensure the formation of a cannula with an even diameter and walls because of the high pressure and speed of the polymeric melt material 1 as it enters and fills the cavity 3.

An additional pressure distribution means may be used for moulding small diameter core pins with a diameter/length ratio of less than around 1:20. The additional pressure distribution means enables the use of longer core pins which, in turn enables moulding cannula 11 with a diameter:length ratio of as little as 1:50.

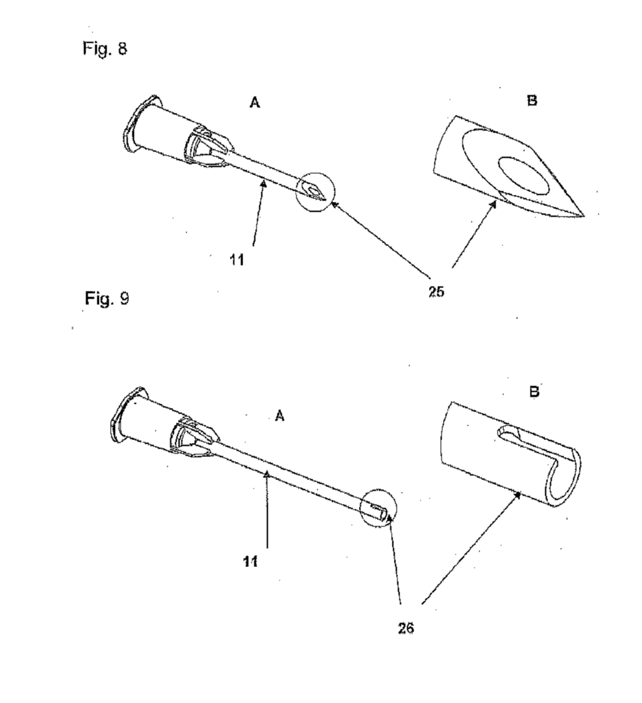

The invention most advantageously provides a pressure distribution means 9 in concentric disposition around the core pin 5. The pressure distribution means 9 provides opposing or biasing pressure to the polymeric melt material 1 as it fills the cavity 3. The pressurised polymeric material 1 quickly fills the available space in the cavity and abuts the end surface 4 of the pressure distribution means 9. The pressure distribution means 9 may take any suitable shape that encircles the core pin, such as a ring or a sleeve. The long axis of the pressure distribution means may vary. Preferably the pressure distribution means 9 is a sleeve of a suitable length. The embodiment in the figures shows the pressure distribution means to be a sleeve. It will be understood that the pressure distribution means may take other forms. The surface 4 of the pressure distribution means 9 can be most conveniently shaped so that the corresponding tip 10 of the forming cannula 11 is suitably angled for effective penetration as a reconstitution needle. The length of the cannula, or whatever article is being formed in the mould, may vary with the axial length of the pressure distribution means 9. Alternatively, the length of the article may be controlled by the distance moved by the electric actuator 16. Three examples of varying length of articles, cannulae in these embodiments, are shown in FIG. 7. The end surface 4 may form any suitable tip geometry. Embodiments with a pointed needle tip 25 and a flat tip 26 are shown in FIGS. 8 and 9. Other embodiments are possible. The tip 10 of the cannula 11 that is formed will mirror whatever surface dimension is chosen for the pressure distribution means end surface 4. FIG. 8A shows an embodiment of a tip 10 with a pointed needle shape, which is enlarged for clarity in FIG. 8B. FIG. 9A shows an alternative embodiment of a tip 10, having a flat shape, which is enlarged for clarity in FIG. 9B. It will be understood that many embodiments of tip ends of the conduit are possible within the scope of the invention.

Inspection of FIGS. 1 to 4 illustrate the ingress of the polymeric material 1 into the cavity 3 from left to right in the mould. The balance of pressures between the injected polymeric material 1 and pressure distribution means results in an even wall thickness of the cannula or article as it is formed. The pressure distribution means 9 provides effective support for the core pin so that the conduit diameter is reproducibly even. This is because the close concentric fit of the core pin within the pressure distribution means operates to prevent bending of the core pin under the high pressure of the polymeric material 1 during injection.

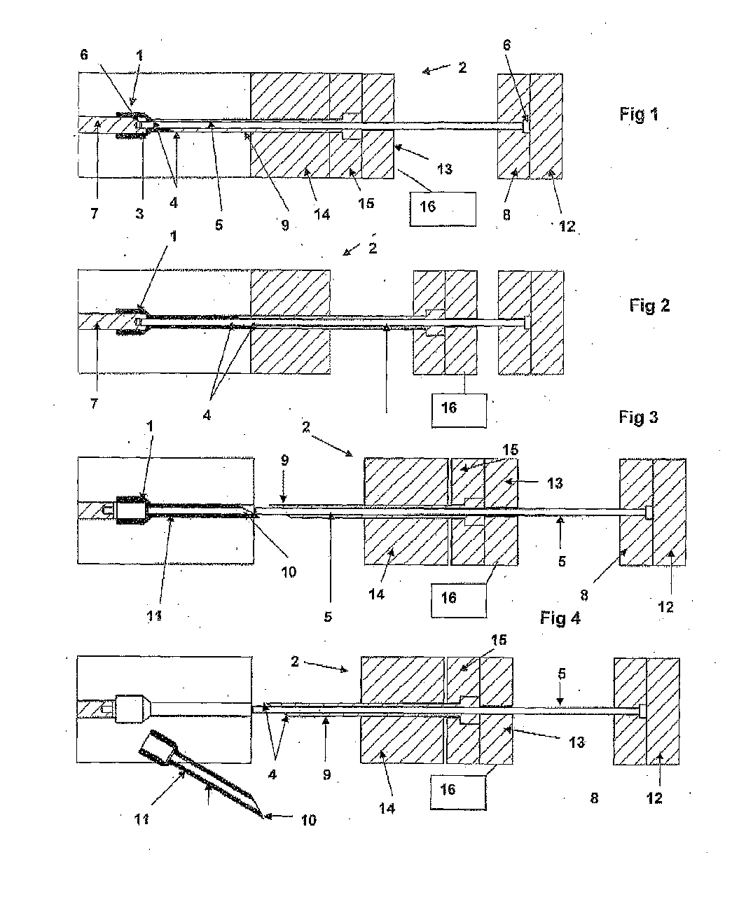

The movement of the pressure distribution means 9 may be controlled by any suitable method. Preferably the movement is controlled by an electric actuator 16 with a servo-motor known in the art. Alternatively, the movement may be hydraulically controlled or another method, such as a spring with suitable tensioning. The control of the movement may be by algorithms implemented in computer software loaded onto a microprocessor. The computer algorithms may include the parameters for the speed, position and acceleration of the pressure distribution means. Inspection of FIGS. 1 and 2 indicates that the position of the electric actuator 16 moves along the longitudinal axis of the core pin 5 and the electric actuator moves closer (FIG. 2) to the distal stabiliser plates 8, 12 while the more liquid polymer 1 fills the cavity 3 of the mould. A guidance block 14 may position the pressure distribution sleeve 9. The pressure distribution means may be radially stabilised with a second stabiliser plate 13 as it moves axially along the core pin and through the guidance block 14. The mould may include a plate locating sleeve 15 for positioning the other elements. The electric actuator 16 is shown adjacent a stabiliser plate for convenience. It will be understood that the arrangement of the stabiliser plates and sleeves may be different in different embodiments.

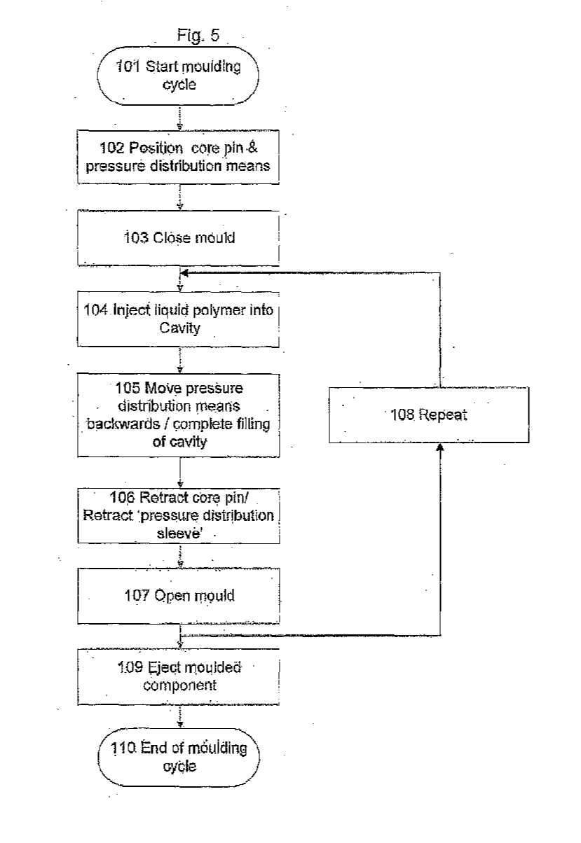

Comparison of FIG. 3 with FIG. 2 shows the distal stabilisers 8, 12 at the most distal point of the moulding cycle. The pressure distribution sleeve 9, guidance block 14, and plates locating sleeve 15 have been moved along the stationary core pin 5 distally by the electric actuator to be spaced from the formed tip 10 of the cannula 11, disengaging the tip-forming end surface 4 of the pressure distribution sleeve 9 from the tip 10. The core pin is retracted distally from the injection end stabiliser 7, leaving a formed article in the form of a cannula. FIG. 4 shows the solidified cannula 11 with formed tip 11 being removed from the cavity of the mould.

The figures herein illustrate an embodiment of the invention having a single conduit in a cannula. The scope of the invention includes a cannula having multiple conduits therein. The scope of the invention includes other articles, the manufacture of which may be effected using the invention. Further, the embodiments disclosed herein comprise of articles which are cannulae. However, any article requiring relatively uniform wall thickness may be manufactured according to the invention, such as rectangular, trapezoid, or the like, in cross-section, object shapes.

The scope of the invention includes the use of multiple shots of multiple injectable materials suitable for injection moulding.

The scope of the invention may be used in conjunction with multi component moulding technique and stack mould technique known in the art.

1. A mould for injection moulding of polymeric materials, the mould comprising at least two parts defining a cavity, the mould comprising:
a conduit portion;
a channel for liquid polymer ingress;
a core pin; and
a pressure distribution means.

2. A mould according to claim 1 wherein said pressure distribution means is a sleeve.

3. A mould according to claim 1 wherein said pressure distribution means is a ring.

4. The mould according to claim 1 wherein the cavity defines a cylinder.

5. The moulding according to claim 1 wherein the conduit portion incorporates a needle portion.

6. A mould according to claim 1 wherein said pressure distribution means incorporates an angled surface for shaping a needle tip.

7. A mould according to claim 1 comprising of multiple conduits in the conduit portion.

8. The mould according to claim 1 wherein the pressure distribution means comprises of a material having efficient heat transfer properties.

9. The mould of claim 7 wherein the pressure distribution means comprises of metal material.

10. The mould according to claim 1 further comprising of a stabiliser for said core pin.

11. A mould according to claim 1 wherein the length of said conduit portion is at least twenty times the diameter of said core pin.

12. A method for forming an article from liquid polymeric material, the method comprising the steps of:
injecting pressurised liquid polymer into the cavity of a mould while providing a resistance pressure against the injecting pressure.

13. The method of claim 12 wherein the provision of a resistance pressure distributes the pressurised liquid polymer throughout the cavity.

14. The method of claim 12 further comprising the step of controlling the resistance pressure with a programmed microprocessor.

15. The method of claim 12 further comprising the step of defining the length of a conduit with said resistance pressure.

16. The method of claim 12 further comprising the step of injecting a second pressurised liquid polymer.

17. The method of claim 16 wherein said second pressurised liquid polymer is different from the first liquid polymer.

18. The method of claim 12 further comprising the step of dispersing the latent heat of said pressurised liquid polymer while providing said resistance pressure.

19. The method of claim 15 wherein the length of said conduit defined with said resistance pressure is at least 20 times the diameter of said conduit.
